(19) United States
(12) Patent Application Publication
(10) Pub. No.: US 2010/0065341 A1
(43) Pub. Date: Mar. 18, 2010

(54) DRIVING SCANNED CHANNEL AND NON-SCANNED CHANNELS OF A TOUCH SENSOR WITH SAME AMPLITUDE AND SAME PHASE

(75) Inventor: Yung Jin Jeon, Uiwang-si (KR)

Correspondence Address: FENWICK & WEST LLP, SILICON VALLEY CENTER, 801 CALIFORNIA STREET, MOUNTAIN VIEW, CA, 94041, US

(73) Assignee: LEADIS TECHNOLOGY, INC., Sunnyvale, CA (US)

(21) Appl. No.: 12/209,903

(22) Filed: Sep. 12, 2008

(51) Int. Cl. G06F 3/044

(52) U.S. Cl. 178/18.06

(57) ABSTRACT

The scanned channel and the non-scanned channels of a capacitive touch sensor are driven by a scan signal and a shield signal, respectively, with the shield signal having a substantially same amplitude and a substantially same phase as the amplitude and the phase, respectively, of the scan signal. Thus, the potentials at both the routing line of the scanned channel and the routing line of the non-scanned channels follow each other and are maintained substantially same regardless of which channel is the scanned one. As a result, the parasitic capacitance arising between the two routing lines is reduced significantly, and the accuracy and the sensitivity of the touch sensor are significantly enhanced.

### BACKGROUND OF THE INVENTION

1. Field of the Invention

The present invention relates to a touch sensitive input device and more specifically, to reducing parasitic capacitance in the scanned channel of a touch sensor.

2. Description of the Related Arts

Modern electronic devices often have touch sensors to receive input data. There are a variety of types of touch sensor applications, such as touch screens, touch buttons, touch switches, touch scroll bars, and the like. Touch sensors have a variety of types, such as resistive type, capacitive type, and electro-magnetic type. A capacitive touch screen is coated with a material, typically indium tin oxide, that conducts continuous electrical current across a sensor. The sensor exhibits a precisely controlled field of stored electrons in both the horizontal and vertical axes of a display to achieve capacitance. The human body is also an electrical device which has stored electrons and therefore also exhibits capacitance. When the sensor's normal capacitance field (its reference state) is altered by another capacitance field, e.g., by the touch with someone's finger, capacitive type touch sensors measure the resultant distortion in the characteristics of the reference field and send the information about the touch event to the touch screen controller for mathematical processing. There are a variety of types of capacitive touch sensors, including Sigma-Delta modulators (also known as capacitance-to-digital converters (CDCs)), charge transfer type capacitive touch sensors, and relaxation oscillator type capacitive touch sensors.

FIG. 1A illustrates a conventional touch sensor 100 including a capacitance-to-digital converter circuit (CDC) 102. Note that FIG. 1 is a simplified diagram illustrating only the parts of the touch sensor 100 circuit necessary for illustration of the conventional touch sensor 100, but does not show all components of the conventional touch sensor 100.

Touch sensor 100 is connected to a plurality of sense capacitors Cbutton0, Cbutton1 through routing lines 108, 110, respectively. Although FIG. 1A shows two sense capacitors Cbutton0, Cbutton1, in practice there may be a much larger number of sense capacitors each corresponding to different locations of the touch sensitive input device with which the touch sensor 100 is used. Routing lines 108, 110 are typically PCB (Printed Circuit Board) traces on a PCB (not shown) on which the touch sensor 100 and sense capacitors Cbutton0, Cbutton1 are placed. Touch pads Touch_Pad0 and Touch_Pad1 are places on the touch sensitive input device where a touch is made for input. Sense capacitors Cbutton0, Cbutton1 are connected to the touch pads Touch_Pad0 and Touch_Pad1, respectively. Sensor pads Sensor_Pad0 and Sensor_pad1 are connection pads of the IC (integrated circuit) on which the touch sensor 100 circuit is formed. Touch pads Touch_Pad0 and Touch_Pad1 are connected to sensor pads Sensor_Pad0 and Sensor_pad1, respectively, via routing lines 108, 110, respectively.

Touch sensor 100 includes CDC circuit 102, and switching devices SEL_S0 and SEL_S1. Switching device SEL_S0 includes MOSFET switch 120 controlled by its gate control signal SEL00. Switching device SEL_S1 includes MOSFET switch 130 controlled by its gate control signal SEL10. Although not explicitly shown in FIG. 1, in one embodiment, gate control signals SEL00 and SEL10 are generated and provided by CDC circuit 102. Also, channel scan signal SCAN is generated and provided by CDC circuit 102 to the drains of MOSFETS 120, 130.

Sense capacitors Cbutton0, Cbutton1 are capacitors that are used to detect changes in charges or capacitances in the sense capacitors caused by a user's touch on corresponding touch pads (Touch_Pad0 and Touch_Pad1) of the touch sensitive input device. When a user touches one of the touch pads (Touch_Pad0 and Touch_Pad1) of the touch sensitive input device, it causes a change in the capacitance of one of the sense capacitors Cbutton0, Cbutton1 corresponding to the touched touch pad. Such change in the capacitance of the sense capacitors is detected by CDC circuit 102, which outputs in the form of binary data 111 that change from “0” to “1” when a touch is made.

As explained above, touch sensitive input devices include a large number of sense capacitors corresponding to the various locations on the touch sensitive input device, although only 2 sense capacitors (Cbutton0, Cbutton1) are shown in FIG. 1A for simplicity of illustration. In order to obviate the need for having as many CDC circuits as the number of sense capacitors present on the touch sensitive input device and to use just one CDC circuit 102 with all the sense capacitors, the CDC circuit 102 employs a multiplexer (not shown) to connect to and detect change of capacitance in only one sense capacitor at a time. Thus, CDC circuit 102 is configured to scan the sense capacitors (Cbutton0, Cbutton1) in a sequential manner, one by one, periodically. In other words, CDC circuit 102 scans one of its multiple “channels” (e.g., routing lines 108, 110) at a time. The time it takes to scan all the sense capacitors (Cbutton0, Cbutton1) (or all channels) is referred to as the “scan period.” One scan period may be, for example, 2 ms. The interval of one scan period may depend on the CDC decimation rate. That is, in one scan period, all the sense capacitors are scanned by CDC circuit 102 sequentially, one at a time, and then in the next scan period the same scanning is repeated again, and so forth. CDC circuit 102 is configured to detect changes in the scanned sense capacitor at any given moment.

When CDC circuit 102 scans one of the channels (i.e., the selected channel or sense capacitor), CDC circuit 102 maintains the remaining non-selected channels at a floating state. This is shown in FIG. 1B, which is a timing diagram illustrating the scanning operation of touch sensor 100 of FIG. 1A.

Referring to FIGS. 1A and 1B together, in period 150 while sense capacitor Cbutton0 is scanned and detected, CDC circuit 102 maintains SEL00 high and SEL10 low, thereby turning on MOSFET 120 and turning off MOSFET 130 and connecting routing line 108 to CDC 102. However routing line 110 remains in floating state. Also, CDC circuit 102 provides scan signal SCAN on the scanned channel (routing line 108) over period 150 with scan signal SCAN being high during the first half of period 150 and low during the second half of period 150. Since MOSFET 120 is on during period 150, the potential at sensor pad Sensor_Pad0 (and channel 108) follows scan signal SCAN. On the other hand, since MOSFET 130 is off during period 150, sensor pad Sensor_Pad1 (and channel 110) remains in floating state. In other words, during period 150, scanned channel 108 follows scan signal SCAN, while non-scanned channel 110 is in floating state.

In period 160 while sense capacitor Cbutton1 is scanned and detected, CDC circuit 102 maintains SEL00 low and SEL10 high, thereby turning off MOSFET 120 and turning on MOSFET 130 and connecting routing line 110 to CDC 102. However routing line 108 remains in floating state. Also, CDC circuit 102 provides scan signal SCAN on the scanned channel (routing line 110) over period 160 with scan signal SCAN being high during the first half of period 160 and low during the second half of period 160. Since MOSFET 130 is on during period 160, the potential at sensor pad Sensor_Pad1 (and channel 110) follows scan signal SCAN. On the other hand, since MOSFET 120 is off during period 160, sensor pad Sensor_Pad0 (and channel 108) remains in floating state. In other words, during period 160, scanned channel 110 follows scan signal SCAN, while non-scanned channel 108 is in floating state.

The different potential between a scanned channel and adjacent non-scanned channels causes the parasitic capacitance between the scanned channel and adjacent non-scanned channels to adversely affect the operation of touch sensor 100. This is shown in FIG. 2, which illustrates the potential parasitic capacitances that may arise between the adjacent channels 108, 110 of the touch sensor 100. Referring to FIG. 2, Cp0tognd is the parasitic capacitance between routing line 108 and ground (GND), Cp1tognd is the parasitic capacitance between routing line 110 and GND, Cp0top1 is the parasitic capacitance between the adjacent routing lines 108, 110 when channel 108 is selected. For example, the total parasitic capacitance on touch pad Touch_Pad0 can be calculated as follows: Cparasitic of Touch_Pad0=Cp0tognd+Cp0top1×Cp1tognd/(Cp0top1×Cp1tognd).

The term Cp0top1×Cp1tognd/(Cp0top1×Cp1tognd) is fairly large, due in large part to the large capacitance of Cp0top1. As explained above, the two routing lines 108, 110 are at different potentials, with the potential on the routing line corresponding to the scanned channel following scan signal SCAN and the potential on the routing line corresponding to the non-scanned channel being at floating state, thereby causing the parasitic capacitance Cp0top1 between the two routing lines 108, 110 to significantly contribute to the total parasitic capacitance on touch pad Touch_Pad0. Such total parasitic capacitance on touch pad Touch_Pad0 significantly degrades the accuracy and sensitivity of touch sensor 100, since touch sensor 100 detects a touch or non-touch on touch pad Touch_Pad0 based on the change in capacitance of sense capacitor Cbutton0 relative to the original capacitance of sense capacitor Cbutton0. The presence of a large total parasitic capacitance on touch pad Touch_Pad0 inappropriately affects the change in capacitance of sense capacitor Cbutton0. Also, note that FIG. 2 merely illustrates the parasitic capacitance between just two adjacent channels 108, 110, but in practice, channel 108 may have another non-selected adjacent channel (not shown in FIG. 2) which may also similarly contribute to the parasitic capacitance between the adjacent channels and further degrade the accuracy and sensitivity of touch sensor 100. Similar degradation in touch sensor sensitivity also occurs when channel 110 is the selected channel.

### SUMMARY OF THE INVENTION

Embodiments of the present invention include a touch sensor coupled to a plurality of sense capacitors and configured to detect changes in the sense capacitors, in which the scanned channel and the non-scanned channels are driven by a scan signal and a shield signal, respectively, with the shield signal having a substantially same amplitude and a substantially same phase as the amplitude and the phase, respectively, of the scan signal. More specifically, the touch sensor comprises a capacitive touch sensor circuit configured to detect a change in a capacitance of a first sense capacitor that is scanned, and a shield signal generator circuit configured to generate a shield signal provided to one or more second sense capacitors that are not scanned. The capacitive touch sensor circuit generates a scan signal and provides the scan signal to the first sense capacitor to detect the change in the capacitance of the first sense capacitor. The shield signal generator circuit generates the shield signal with a substantially same amplitude and a substantially same phase as the amplitude and the phase, respectively, of the scan signal.

Thus, the potentials on the routing lines of both the scanned channel and the non-scanned channels follow each other and are maintained substantially the same regardless of which channel is the scanned one. As a result, the parasitic capacitance arising between the two routing lines is reduced significantly, and the accuracy and the sensitivity of the touch sensor are significantly enhanced.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the embodiments of the present invention can be readily understood by considering the following detailed description in conjunction with the accompanying drawings.

FIG. 1A illustrates a conventional touch sensor including a conventional capacitance-to-digital converter circuit (CDC).

FIG. 1B is a timing diagram illustrating the scanning operation of the conventional touch sensor of FIG. 1A.

FIG. 2 illustrates the potential parasitic capacitances that may arise between the adjacent channels of the conventional touch sensor of FIG. 1A.

FIG. 3A illustrates a touch sensor including a capacitance-to-digital converter circuit (CDC), according to one embodiment of the present invention.

FIG. 3B is a timing diagram illustrating the scanning operation of the touch sensor of FIG. 3A, according to one embodiment of the present invention.

FIG. 4A illustrates a capacitance to digital converter (CDC) circuit used with the touch sensor of FIG. 3A, according to one embodiment of the present invention.

FIG. 4B illustrates the operation of the CDC circuit of FIG. 4A in one phase, according to one embodiment of the present invention.

FIG. 4C illustrates the operation of the CDC circuit of FIG. 4A in another phase, according to one embodiment of the present invention.

FIG. 5A is a timing diagram illustrating the operation of the CDC circuit of FIG. 4A, when the capacitance on the sense capacitor is not disturbed by a touch on the corresponding touch pad.

FIG. 5B is a timing diagram illustrating the operation of the CDC circuit of FIG. 4A, when the capacitance on the sense capacitor is disturbed by a touch on the corresponding pad.

### DETAILED DESCRIPTION OF EMBODIMENTS

The Figures (FIG.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

According to various embodiments of the present invention, non-scanned channels of a touch sensor are driven by a duplicate signal that has substantially the same amplitude and substantially the same phase as the amplitude and the phase, respectively, of the scan signal driving the scanned channel of the touch sensor. As a result, the parasitic capacitance between the scanned channel and adjacent non-scanned channels are significantly reduced, thereby enhancing the accuracy and sensitivity of the touch sensor.

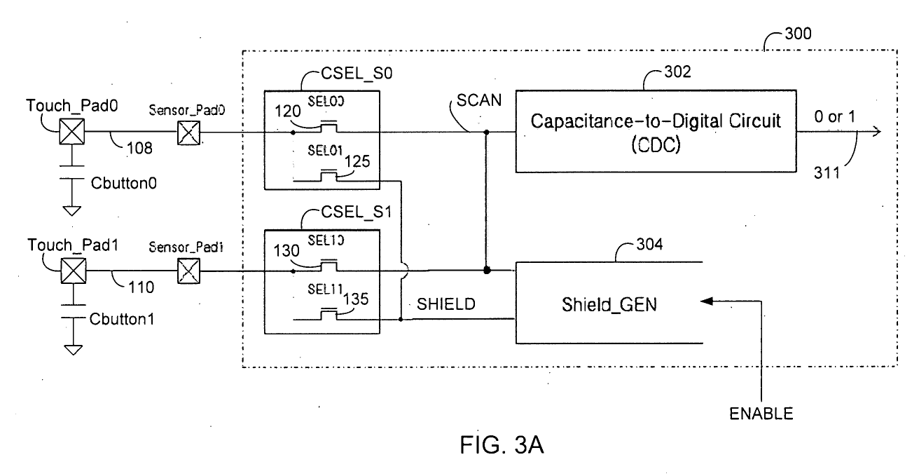

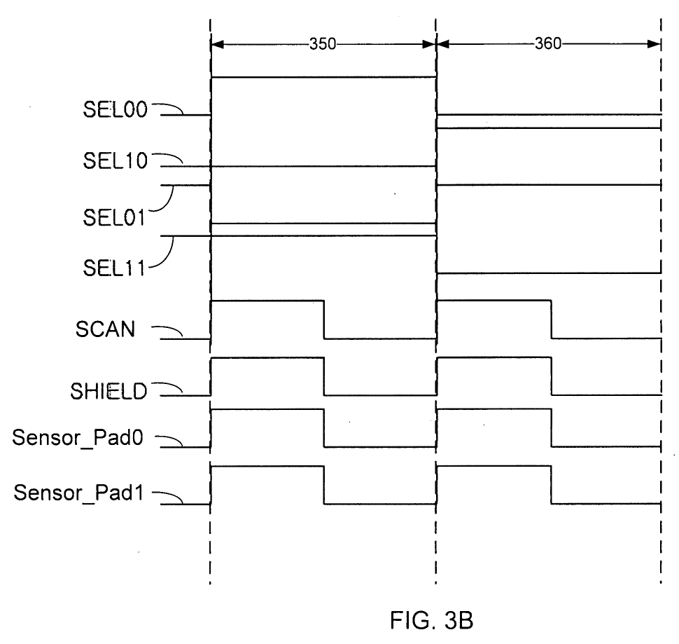

Turning to the figures, FIG. 3A illustrates a touch sensor including a capacitance-to-digital converter circuit (CDC), according to one embodiment of the present invention. Note that FIG. 3 illustrates only the parts of touch sensor 300 circuit necessary for explanation of the invention, for simplicity of illustration, but does not necessarily show all components of the touch sensor.

Touch sensor 300 is connected to a plurality of sense capacitors Cbutton0, Cbutton1 through routing lines 108, 110, respectively. Although FIG. 3A shows two sense capacitors Cbutton0, Cbutton1, in practice there may be a much larger number of sense capacitors each corresponding to different locations (touch pads) of the touch sensitive input device with which the touch sensor 300 is used. Routing lines 108, 110 are typically PCB (Printed Circuit Board) traces on a PCB (not shown) on which the touch sensor 300 and sense capacitors Cbutton0, Cbutton1 are placed and may also be implemented as cables. Touch pads Touch_Pad0 and Touch_Pad1 are places on the touch sensitive input device where a touch is made for input. Sense capacitors Cbutton0, Cbutton1 are connected to the touch pads Touch_Pad0 and Touch_Pad1, respectively. Sensor pads Sensor_Pad0 and Sensor_pad1 are connection pads of the IC (integrated circuit) on which the touch sensor 300 circuit is formed. Touch pads Touch_Pad0 and Touch_Pad1 are connected to sensor pads Sensor_Pad0 and Sensor_Pad1, respectively, via routing lines 108, 110, respectively.

Touch sensor 300 includes CDC circuit 302, shield signal generator circuit (Shield GEN) 304, and switching devices CSEL_S0 and CSEL_S1. Although CDC 302 is shown in FIG. 3A as an example of a capacitive touch sensor circuit, other types of capacitive touch sensor circuits may be used with the embodiments of the present invention. Switching device CSEL_S0 includes MOSFET switch 120 controlled by its gate control signal SEL00 and MOSFET switch 125 controlled by its gate control signal SEL01. Switching device CSEL_S1 includes MOSFET switch 130 controlled by its gate control signal SEL10 and MOSFET switch 135 controlled by its gate control signal SEL11. The source of MOSFET 125 is connected to the source of MOSFET 120, and the drain of MOSFET 125 is connected to the drain of MOSFET 135. The source of MOSFET 135 is connected to the source of MOSFET 130, and the drain of MOSFET 135 is connected to the drain of MOSFET 125. The sources of MOSFETS 120, 125 are connected to sensor pad Sensor_Pad0, and the sources of MOSFETS 130, 135 are connected to sensor pad Sensor_Pad1. Although not explicitly shown in FIG. 3, gate control signals SEL00, SEL01, SEL10, and SEL11 are generated and provided by CDC circuit 302.

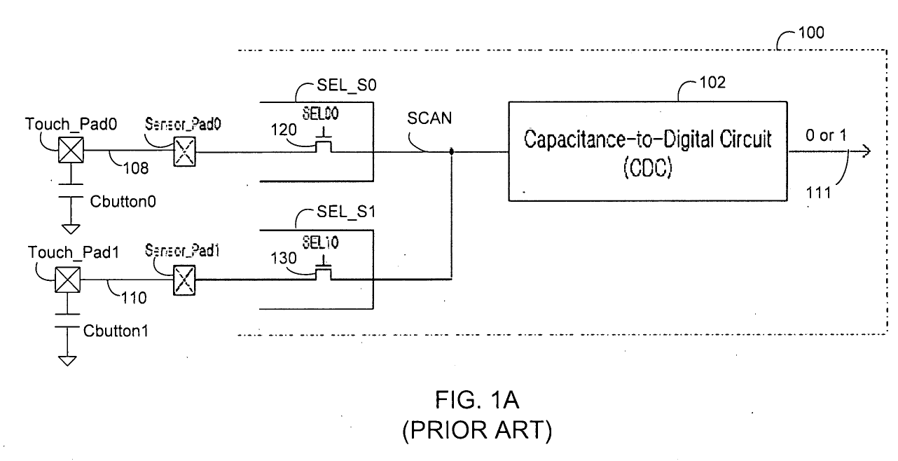

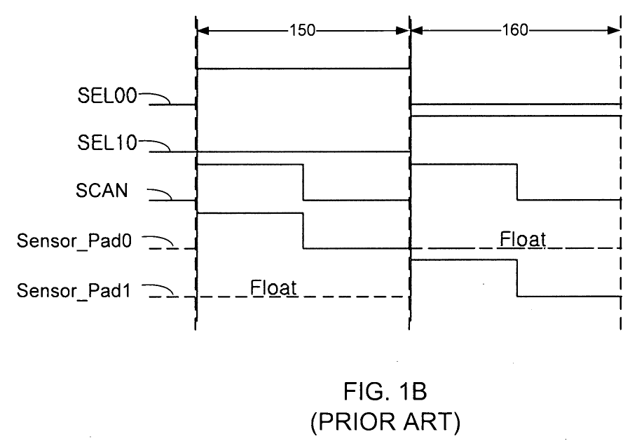

Also, CDC circuit 302 generates channel scan signal SCAN and provides it to the drains of MOSFETS 120, 130. Shield signal generator circuit 304 generates a shield signal SHIELD, which is provided to the drains of MOSFETS 125, 135. Shield signal generator circuit 304 generates the shield signal SHIELD to have a substantially same amplitude and a substantially same phase as the amplitude and phase, respectively, of channel scan signal SCAN. Shield signal generator circuit 304 can generate such shield signal SHIELD, based on known parameters of scan signal SCAN such as the rising time, falling time, high voltage, and low voltage of scan signal SCAN, using any type digital or analog circuitry. In one embodiment, shield signal generator circuit 304 may be pre-programmed with such parameters of the channel scan signal SCAN to generate the shield signal SHIELD. In another embodiment, such parameters of the channel scan signal SCAN may be provided by the CDC circuit 302 to the shield signal generator circuit 304. Note that the functions of shield signal generator circuit 304 may be enabled or disabled according to an enable signal EN. If the shield signal generator circuit 304 is disabled, touch sensor 300 operates similarly to the conventional touch sensor 100 of FIG. 1A. The following description assumes that shield signal generator circuit 304 is enabled according to the enable signal EN.

Sense capacitors Cbutton0, Cbutton1 are capacitors that are used to detect changes in charges or capacitances in the sense capacitors caused by a user's touch on the corresponding touch pads (Touch_Pad0 and Touch_Pad1) of the touch sensitive input device. When a user touches one of the touch pads (Touch_Pad0 and Touch_Pad1) of the touch sensitive input device, a change occurs in the capacitance of one of the sense capacitors Cbutton0, Cbutton1 corresponding to the location of the touched touch pad. Such change in the capacitance of the sense capacitor is detected by CDC circuit 302, which outputs in the form of binary data 311 that change from “0” to “1” when a touch is made.

As explained above, touch sensitive input devices include a large number of sense capacitors corresponding to the various locations on the touch sensitive input device, although only 2 sense capacitors (Cbutton0, Cbutton1) are shown in FIG. 3A for simplicity of illustration. In order to obviate the need for having as many CDC circuits as the number of sense capacitors present on the touch sensitive input device and to use just one CDC circuit 302 with all the sense capacitors, CDC circuit 302 employs a multiplexer (not shown) to connect to and detect change of capacitance in only one sense capacitor at a time. Thus, CDC circuit 302 is configured to scan the sense capacitors (Cbutton0, Cbutton1) in a sequential manner, one by one, periodically. In other words, CDC circuit 302 scans one of its multiple “channels” (e.g., routing lines 108, 110) at a time. The time it takes to scan all the sense capacitors (Cbutton0, Cbutton1) (or all channels) is referred to as the “scan period.” One scan period may be, for example, 2 ms. The interval of one scan period may depend on the CDC decimation rate. That is, in one scan period, all the sense capacitors are scanned by CDC circuit 302 sequentially, one at a time, and then in the next scan period the same scanning is repeated again, and so forth. CDC circuit 302 is configured to detect changes in the scanned sense capacitor at any given moment.

When CDC circuit 302 scans one of the channels (i.e., the selected channel or sense capacitor) using its scan signal SCAN, the non-selected channels are driven at substantially the same potential as the selected channels at substantially same phases using the SHIELD signal. In one embodiment, all the non-selected channels are driven by the shield signal SHIELD when the selected channel is driven by the scan signal SCAN. In another embodiment, at least the non-selected channels adjacent to the selected channel are driven by the shield signal SHIELD when the selected channel is driven by the scan signal SCAN. This is shown in FIG. 3B, which is a timing diagram illustrating the scanning operation of touch sensor 300 of FIG. 3A, according to one embodiment of the present invention.

Referring to FIGS. 3A and 3B together, in period 350 while sense capacitor Cbutton0 is scanned and detected, CDC circuit 302 maintains SEL00 high and SEL10 low, thereby turning on MOSFET 120 and turning off MOSFET 130 and connecting routing line 108 to CDC 302. In addition, CDC circuit 302 maintains SEL01 low, same as SEL10, and maintains SEL11 high, same as SEL00, thereby turning off MOSFET 125 and turning on MOSFET 135. As a result, routing line 108 is connected to CDC circuit 302 via sensor pad Sensor_Pad0 and MOSFET 120, while routing line 110 is connected to the shield signal generator circuit 304 via sensor pad Sensor_Pad1 and MOSFET 135.

CDC circuit 302 provides scan signal SCAN on the scanned channel (routing line 108) over a period 350 with scan signal SCAN being high during the first half of period 350 and low during the second half of period 350. In addition, CDC circuit 302 provides shield signal SHIELD on the non-scanned channel (routing line 110) over a period 350 with shield signal SHIELD being high during the first half of period 350 and low during the second half of period 350, with substantially the same amplitude and substantially the same phase as the amplitude and the phase of scan signal SCAN. The shield signal SHIELD may be provided to only the non-scanned channels adjacent to the scanned channel in one embodiment, or to all the non-scanned channels in another embodiment.

Since MOSFET 120 is on during period 350, the potential at sensor pad Sensor_Pad0 (and channel 108) follows scan signal SCAN. MOSFET 125 is off, so the shield signal SHIELD does not affect the scanned channel 108. On the other hand, since MOSFET 135 is on during period 350, the potential at sensor pad Sensor_Pad1 (and channel 110) follows shield signal SHIELD, which is same as scan signal SCAN. Thus, the potentials at both the routing line 108 of the scanned channel and the routing line 110 of the non-scanned channel follow each other and are maintained substantially same regardless of which channel is the scanned one. MOSFET 130 is off, so the scan signal SCAN does not affect the non-scanned channel 110.

In period 360 while sense capacitor Cbutton1 is scanned and detected, CDC circuit 302 maintains SEL00 low and SEL10 high, thereby turning off MOSFET 120 and turning on MOSFET 130 and connecting routing line 110 to CDC 302. In addition, CDC circuit 302 maintains SEL01 high, same as SEL10, and maintains SEL11 low, same as SEL00, thereby turning on MOSFET 125 and turning off MOSFET 135. As a result, routing line 110 is connected to the CDC circuit 302 via sensor pad Sensor_Pad1 and MOSFET 130, while routing line 108 is connected to the shield signal generator circuit 304 via sensor pad Sensor_Pad0 and MOSFET 125.

CDC circuit 302 provides scan signal SCAN on the scanned channel (routing line 110) over a period 360 with scan signal SCAN being high during the first half of period 360 and low during the second half of period 360. In addition, CDC circuit 302 provides shield signal SHIELD on the non-scanned channel (routing line 108) over a period 360 with shield signal SHIELD being high during the first half of period 360 and low during the second half of period 360, with substantially the same amplitude and substantially the same phase as the amplitude and the phase of scan signal SCAN. The shield signal SHIELD may be provided to just the non-scanned channels adjacent to the scanned channel in one embodiment, or to all the non-scanned channels in another embodiment.

Since MOSFET 130 is on during period 360, the potential at sensor pad Sensor_Pad1 (and channel 110) follows scan signal SCAN. MOSFET 135 is off, so the shield signal SHIELD does not affect the scanned channel 110. On the other hand, since MOSFET 125 is on during period 360, the potential at sensor pad Sensor_Pad0 (and channel 108) follows shield signal SHIELD, which is same as scan signal SCAN. Thus, the potentials at both the routing line 110 of the scanned channel and the routing line 108 of the non-scanned channel follow each other and are maintained substantially same regardless of which channel is the scanned one. MOSFET 120 is off, so the scan signal SCAN does not affect the non-scanned channel 108.

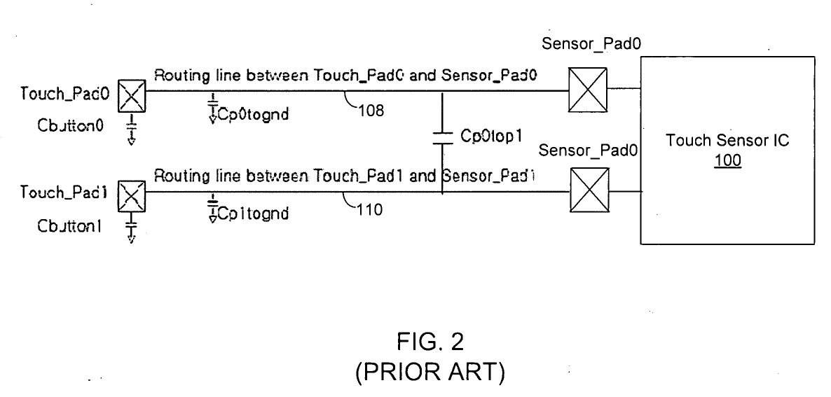

Since the potentials at both routing lines 108, 110 are maintained substantially the same regardless of which channel is the selected, scanned channel, the parasitic capacitance arising between the two routing lines 108, 110 are reduced significantly. As explained above with reference to FIG. 2, the total parasitic capacitance on touch pad Touch_Pad0 when sensor pad Sensor_Pad0 is scanned can be calculated as follows: Cparasitic of Touch_Pad0=Cp0tognd+Cp0top1×Cp1tognd/(Cp0top1×Cp1tognd), where Cp0tognd is the parasitic capacitance between routing line 108 and ground (GND), Cp1tognd is the parasitic capacitance between routing line 110 and GND, Cp0top1 is the parasitic capacitance between the adjacent routing lines 108, 110. However, since the there is no difference in potential in the routing lines 108, 110, the parasitic capacitance Cp0top1 between the adjacent routing lines 108, 110 becomes negligible, close to substantially zero. Thus, the total parasitic capacitance on touch pad Touch_Pad0 when sensor pad Sensor_Pad0 is scanned is: Cparasitic of Touch_Pad0=Cp0tognd. Similarly, the total parasitic capacitance on touch pad Touch_Pad1 when sensor pad Sensor_Pad1 is scanned is: Cparasitic of Touch_Pad1=Cp1tognd. Since the total parasitic capacitance on touch pad Touch_Pad0 or Touch_Pad1 is significantly smaller than in the case of the conventional touch sensor 100 in FIG. 1A, the accuracy and the sensitivity of touch sensor 300 are significantly enhanced compared to the conventional touch sensor 100 in FIG. 1A.

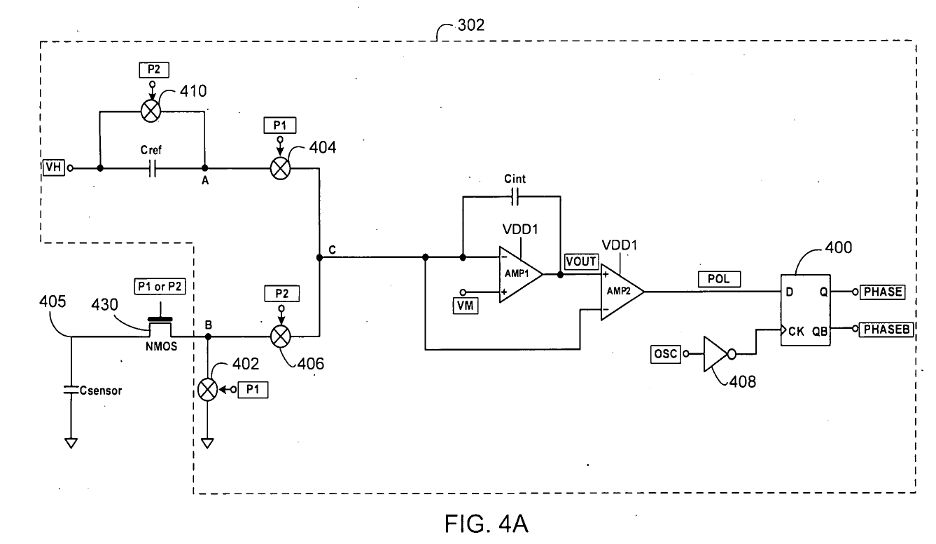

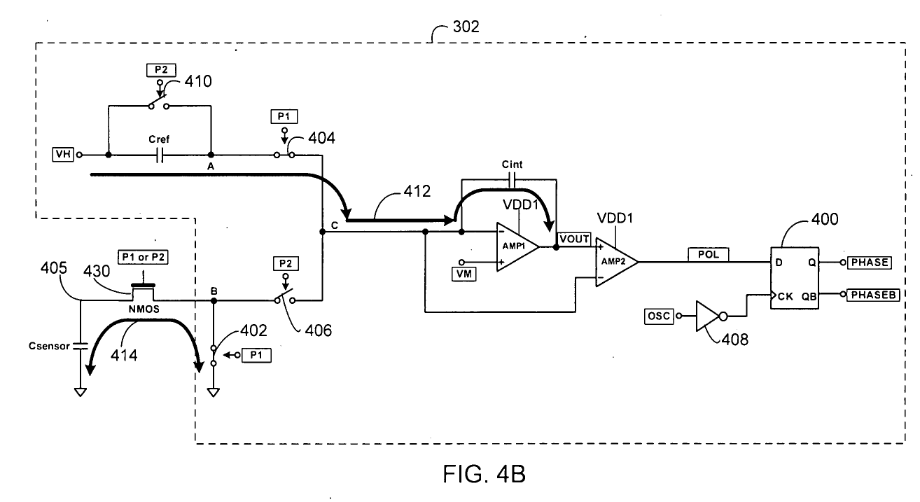

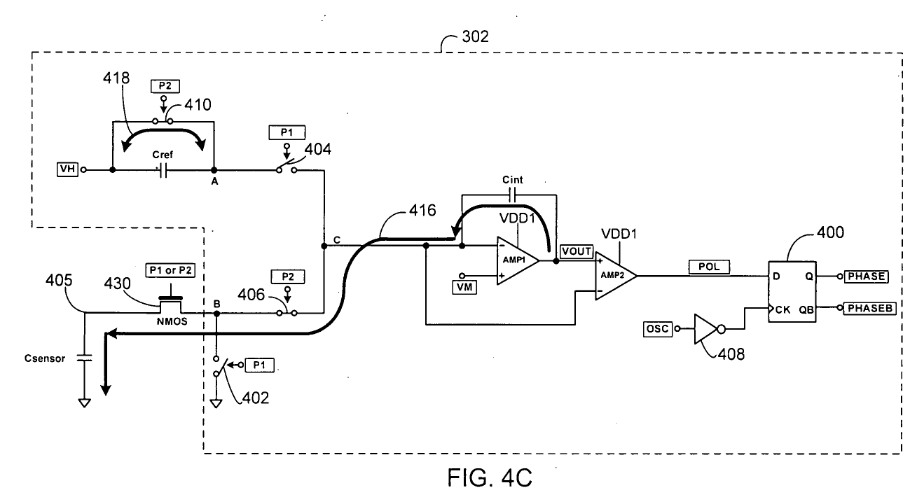

FIG. 4A illustrates the capacitance to digital converter (CDC) circuit 302 used with the touch sensor 300 of FIG. 3A, according to one embodiment of the present invention. FIG. 4A illustrates the situation when one of the channels (108, 110) is already selected and scanned. Thus, routing line 405 in FIG. 4A may be any one of routing lines 108, 110 that is selected and scanned in FIG. 3A, and sense capacitor Csensor may be any one of sense capacitor Cbutton0 or Cbutton1 that is selected and scanned in FIG. 3A. Other components of the circuitry in FIG. 3A such as the touch pads Touch_Pad0, Touch_Pad1, sensor pads Sensor_Pad0, Sensor_Pad1, switch modules CSEL_S0, CSEL_S1, shield signal generator circuit 304, etc. are omitted from FIG. 4A for simplicity of illustration. For purposes of illustration, it may be assumed that one of the channels is selected and scanned, for example, routing line 108 and sense capacitor Cbutton0 correspond to routing line 405 and sense capacitor Csensor, respectively.

One sense capacitor Csensor is shown as connected to the CDC 302 at node 405, which corresponds to one of the routing lines (e.g., 108 or 110) in FIG. 3A, through N-type MOSFET (Metal Oxide Semiconductor Field Effect Transistor) 430. NMOS 430 protects the CDC 302 from high voltages, for example, a high voltage that may be used with an LED driver (not shown) integrated together with the touch sensor 302 on a single IC.

Referring to FIG. 4A, CDC circuit 302 includes reference capacitor C_{ref}, switches 410, 404, 406, 402, amplifiers AMP1, AMP2, capacitor Cᵢₙₜ, an inverter 408, and a D-type flip flop 400. N-type MOSFET 430 is connected in series with the CDC circuit 302 at node B between the two switches 402, 406 and the sense capacitor Cₛₑₙₛₒᵣ. The sense capacitor Cₛₑₙₛₒᵣ is connected in series with the NMOS 430, between NMOS 430 and ground. Switch 402 is connected between node B and ground. Switch 406 is connected between nodes B and C. Switch 404 is connected between nodes A and C. Switch 410 is connected in parallel with the reference capacitor C_{ref}, between voltage VH and node A. Amplifier AMP1 receives the voltage at node C at its negative input terminal and a DC voltage VM at its positive voltage terminal. DC voltage VM is lower than DC voltage VH. Amplifier AMP1 and capacitor Cᵢₙₜ form an integrator integrating the voltage at node C and outputs an integrated output voltage VOUT. Amplifier AMP2 compares VOUT at its positive input terminal to the voltage at node C at its negative input terminal, and outputs POL. POL is the data input to the D type flip flop 400. The D type flip flop 400 is operated by a clock signal that is inverted from the oscillator signal OSC by the inverter 408. The non-inverted output of the D type flip flop 400 is the PHASE signal and the inverted output of the D type flip flop 400 is the PHASEB signal. The PHASE signal corresponds to signal 311 output from touch sensor 302 (see FIG. 3A), and the number of pulses in the PHASE signal is counted by a counter (not shown herein) to determine whether the change in capacitance in the sense capacitor Csensor was caused by a valid touch on the corresponding touch pad.

A non-overlapping 2-phase clock signal (P1 or P2) formed by clock signals P1 and P2 is applied to the gate of NMOS 430 to control the turning on and off of the NMOS 430. As will be explained in more detail below, the clock signals P1 and P2 are non-overlapping in the sense that they are not at logic high at the same time. In other words, if the clock signal P1 is at logic high, the clock signal P2 is at logic low. If the clock signal P2 is at logic high, the clock signal P1 is at logic low. Switches 402, 404 are turned on and off according to the clock signal P1, while switches 406, 410 are turned on and off according to the clock signal P2.

FIG. 4B illustrates the operation of the CDC circuit of FIG. 4A in one phase, according to one embodiment of the present invention. The example of FIG. 4B illustrates the situation where the clock signal P1 is at logic high and the clock signal P2 is at logic low. Accordingly, switches 402, 404 are turned on, and switches 406, 410 are turned off. NMOS 430 is turned on due to clock signal P1. Thus, the charges stored in the sense capacitor Cₛₑₙₛₒᵣ are discharged 414 to ground through the NMOS 430 and the switch 402, thereby resetting the sense capacitor Cₛₑₙₛₒᵣ. Since switch 406 is turned off, the sense capacitor Cₛₑₙₛₒᵣ is disconnected from node C. In contrast, the reference capacitor C_{ref} is connected to node C through the switch 404. Positive DC voltage VH charges 412 capacitor Cᵢₙₜ connected to the negative input of the amplifier AMP1, whose voltage is integrated to generate VOUT. Thus, VOUT is negative and POL is also negative, resulting in the PHASE signal of “0” and PHASEB signal of “1” sampled at the clock frequency of the D-type flip flop 400.

FIG. 4C illustrates the operation of the CDC circuit of FIG. 4A in another phase, according to one embodiment of the present invention. The example of FIG. 4C illustrates the situation where the clock signal P1 is at logic low and the clock signal P2 is at logic high. Accordingly, switches 402, 404 are turned off and switches 406, 410 are turned on. NMOS 430 is turned on due to clock signal P2. In this situation, the sense capacitor Cₛₑₙₛₒᵣ is connected to node C through NMOS 430 and the switch 406. Thus, the charges from the integration capacitor Cᵢₙₜ are stored 416 in the sense capacitor Cₛₑₙₛₒᵣ through the NMOS 430 and the switch 406. Thus, VOUT is positive and POL is also positive, resulting in the PHASE signal of “1” and PHASEB signal of “0” sampled at the clock frequency of the D-type flip flop 400. Since switch 404 is turned off, the reference capacitor C_{ref} is disconnected from node C and is discharged (reset) 418.

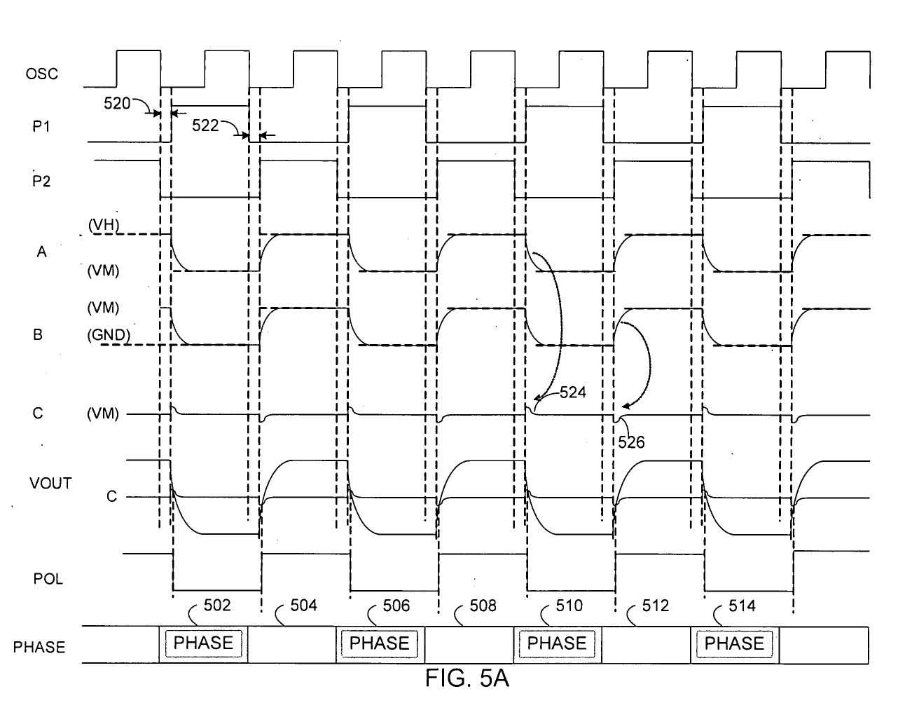

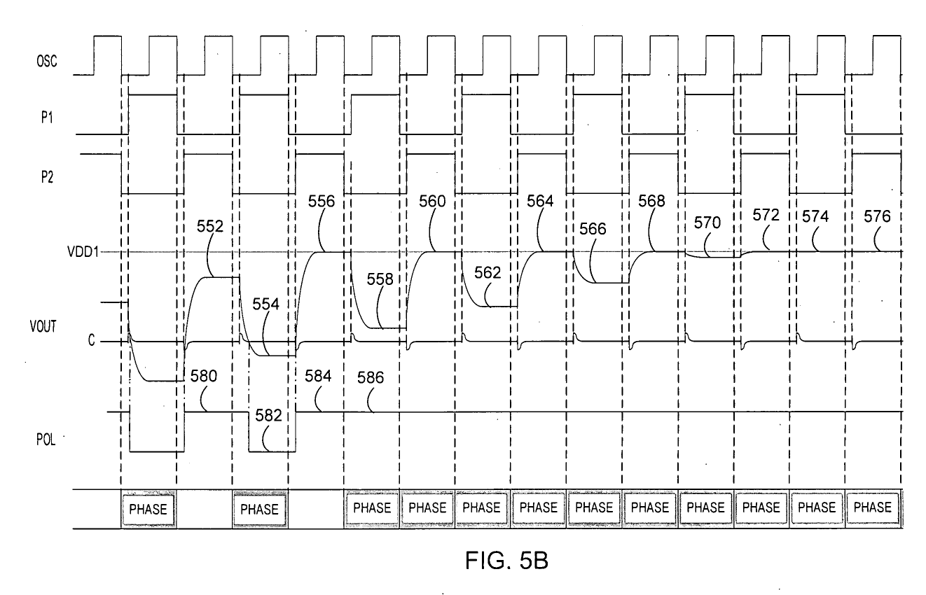

FIG. 5A is a timing diagram illustrating the operation of the CDC circuit of FIG. 4A, when the capacitance on the sense capacitor is not disturbed by a touch on the corresponding touch pad. FIG. 5A is explained in conjunction with FIG. 4A. As shown in FIG. 5A, the oscillator signal OSC provides the inverted clock signal for the D-type flip flop 400. OSC may also be the system clock used by touch sensor 300. The PHASE signals are sampled 502, 504, . . . , 514 by the D type flip flop 400 at the falling edge of the OSC signal, due to the inverter 408. Signals P1 and P2 together form a non-overlapping 2-phase clock signal, where P1 is at logic high while P2 is at logic low, and P2 is at logic high while P1 is at logic low. Break-before-make intervals 520, 522 are built into the clock signals P1, P2 so that clock signals P1, P2 are not at logic high at the same time.

The voltage at node A transitions from VH to VM when P1 transitions to logic high, and transitions from VM to VH when P2 transitions to logic high. VH is a DC voltage applied to one end of the reference capacitor C_{ref}, and VM is another DC voltage lower than VH and applied to the positive input of the amplifier AMP1. The voltage at node B transitions from VM to ground when P1 transitions to logic high, and transitions from ground to VM when P2 transitions to logic high. This is because the voltage at node C is approximately the same as VM with ripples 524 occurring when P1 transitions to logic high and ripples 526 occurring when P2 transitions to logic high. That is, the DC components of the voltage at node C are the same as the voltage VM.

As explained above, the output VOUT of the integrator (AMP1, Cᵢₙₜ) transitions to logic low when P1 transitions to logic high, and transitions to logic high when P2 transitions to logic high. In this manner, VOUT alternates between low voltage and high voltage when the capacitance on the sense capacitor Cₛₑₙₛₒᵣ is not disturbed by a touch on the corresponding key. Likewise, the output POL of the amplifier AMP2 transitions to logic low when P1 transitions to logic high, and transitions to logic high when P2 transitions to logic high. In this manner, POL alternates between logic low and logic high when the capacitance on the sense capacitor Cₛₑₙₛₒᵣ is not disturbed by a touch on the corresponding key. As a result, PHASE outputs a data stream 502, 504, 506, 508, 510, 512, 514 of “1010101 . . . ” when the capacitance on the sense capacitor Cₛₑₙₛₒᵣ is not disturbed by a touch on the corresponding key.

FIG. 5B is a timing diagram illustrating the operation of the CDC circuit of FIG. 4A, when the capacitance on the sense capacitor Cₛₑₙₛₒᵣ is disturbed by a touch on the corresponding pad. The timing diagram of FIG. 5B shows the same signals as those shown in FIG. 5A, except that the voltages at nodes A, B, and C are not shown for simplicity of illustration. When the capacitance on the sense capacitor Cₛₑₙₛₒᵣ is disturbed by a touch on the corresponding touch key, VOUT starts to increase in each cycle 552, 554, 556, 558, 560, 562, 564, 566, 568, 570 and maintains the high voltage 572, 574, 576 saturated at the supply voltage VDD1 of the CDC circuit 302. POL alternates between logic high 580 and logic low 582 as explained previously with reference to FIG. 5B until the point where VOUT does not fall below the voltage at node C (see 558). At that point, the POL also does not return to logic low (i.e., maintains logic high (see 586)). As a result, PHASE outputs a continuous data stream of 1's soon after the capacitance on the sense capacitor Cₛₑₙₛₒᵣ is disturbed by a touch on the touch screen. The PHASE data stream shown in FIG. 5B would be “10101111111111 . . . ” The number of times the PHASE data stream 311 is continuously “1” is counted by a counter (not shown herein) to determine how long sense capacitor Cₛₑₙₛₒᵣ is disturbed by a touch on the corresponding touch pad. When the touch is removed, the PHASE signal will revert to an alternating data stream of “1010101 . . . ” as shown in FIG. 5A, although not shown in FIG. 5B.

Upon reading this disclosure, those of skill in the art will appreciate still additional alternative designs for a method and apparatus for reducing parasitic capacitance between the scanned channel and non-scanned channels of a touch sensor. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A touch sensor coupled to a plurality of sense capacitors and configured to detect changes in the sense capacitors, the touch sensor comprising:
a capacitive touch sensor circuit configured to detect a change in a capacitance of a first sense capacitor that is scanned, the capacitive touch sensor circuit generating a scan signal provided to the first sense capacitor to detect the change in the capacitance of the first sense capacitor; and
a shield signal generator circuit configured to generate a shield signal provided to one or more second sense capacitors that are not scanned, the shield signal generated with a substantially same amplitude and a substantially same phase as an amplitude and a phase, respectively, of the scan signal.

2. The touch sensor of claim 1, wherein the shield signal generator circuit is configured to provide the shield signal to all the second sense capacitors that are not scanned.

3. The touch sensor of claim 1, wherein the shield signal generator circuit is configured to provide the shield signal to all the second sense capacitors that are not scanned and are adjacent to the first sense capacitor that is scanned.

4. The touch sensor of claim 1, wherein the touch sensor further includes:
a first switch coupled to the capacitive touch sensor circuit, the first switch turned on to connect the capacitive touch sensor circuit with said first sense capacitor that is scanned via a first routing line;
a second switch coupled to the shield signal generator circuit, the second switch turned off to block the shield signal from the first sense capacitor;
one or more third switches each coupled to the capacitive touch sensor circuit, the third switches turned off to block the scan signal from a corresponding one of said one or more second sense capacitors that are not scanned; and
one or more fourth switches each coupled to the shield signal generator circuit, the fourth switches turned on to connect the shield signal generator circuit with a corresponding one of said one or more second sense capacitors via a corresponding one of one or more second routing lines.

5. The touch sensor of claim 4, wherein the first routing line and the one or more second routing lines are at a substantially same potential at a given time.

6. The touch sensor of claim 4, wherein the first switch and said one or more fourth switches are turned on or off together, and the second switch and said one or more third switches are turned on or off together opposite to the turning on or off of the first switch and said one or more fourth switches.

7. The touch sensor of claim 4, wherein the scan signal is provided to the first sense capacitor via the first routing line, and the shield signal is provided to said one or more second capacitors via the corresponding one of the second routing lines.

8. The touch sensor of claim 4, wherein a parasitic capacitance between the first routing line and said one or more second routing lines is substantially removed by the scan signal and the shield signal.

9. The touch sensor of claim 4, wherein both the first switch and the second switch are connected to the first routing line, and both said one or more third switches and said one or more fourth switches are connected to the second routing line.

10. The touch sensor of claim 1, wherein the shield signal generator circuit is enabled or disabled according to an enable signal.

11. The touch sensor of claim 1, wherein the capacitive touch sensor circuit comprises a capacitance-to-digital converter circuit.

12. A method of operating a touch sensor coupled to a plurality of sense capacitors and including a capacitive touch sensor circuit configured to detect changes in the sense capacitors, the method comprising:
providing a scan signal to a first sense capacitor that is scanned by the capacitive touch sensor circuit to detect a change in a capacitance of the first sense capacitor; and
providing a shield signal generated by a shield signal generator circuit to one or more second sense capacitors that are not scanned by the capacitive touch sensor circuit, the shield signal being with a substantially same amplitude and a substantially same phase as an amplitude and a phase, respectively, of the scan signal.

13. The method of claim 12, wherein the shield signal is provided to all the second sense capacitors that are not scanned by the capacitive touch sensor circuit.

14. The method of claim 12, wherein the shield signal is provided to all the second sense capacitors that are not scanned and are adjacent to the first sense capacitor that is scanned.

15. The method of claim 12, wherein the touch sensor further includes a first switch coupled to the capacitive touch sensor circuit, a second switch coupled to the shield signal generator circuit, one or more third switches each coupled to the capacitive touch sensor circuit, and one or more fourth switches each coupled to the shield signal generator circuit, and the method further comprises:
turning on the first switch to connect the capacitive touch sensor circuit with said first sense capacitor that is scanned via a first routing line;
turning off the second switch to block the shield signal from the first sense capacitor;
turning off the third switches to block the scan signal from a corresponding one of said one or more second sense capacitors that are not scanned; and
turning on the fourth switches to connect the shield signal generator circuit with a corresponding one of said one or more second sense capacitors via a corresponding one of one or more second routing lines.

16. The method of claim 15, wherein the first routing line and the one or more second routing lines are at a substantially same potential at a given time.

17. The method of claim 15, wherein the first switch and said one or more fourth switches are turned on or off together, and the second switch and said one or more third switches are turned on or off together opposite to the turning on or off of the first switch and said one or more fourth switches.

18. The method of claim 15, wherein the scan signal is provided to the first sense capacitor via the first routing line, and the shield signal is provided to said one or more second capacitors via the corresponding one of the second routing lines.

19. The method of claim 15, wherein a parasitic capacitance between the first routing line and said one or more second routing lines is substantially removed by the scan signal and the shield signal.

20. The method of claim 15, wherein both the first switch and the second switch are connected to the first routing line, and both said one or more third switches and said one or more fourth switches are connected to the second routing line.

21. The method of claim 12, wherein the shield signal generator circuit is enabled or disabled according to an enable signal.

22. The method of claim 12, wherein the capacitive touch sensor circuit comprises a capacitance-to-digital converter circuit.
